(19) United States
(12) Patent Application Publication
(10) Pub. No.: US 2026/0208113 A1
(43) Pub. Date: Jul. 23, 2026

(54) TANGENTIAL FLOW FILTRATION MANIFOLD ASSEMBLY

(71) Applicant: Merck Patent GmbH, Darmstadt (DE)

(72) Inventors: Robert Langlois, Groton, MA (US); James J. Vigna, Tyngsborough, MA (US); Sebastien Cirou, Hochstati (FR); Christine Crequy, Eschau (FR); Olivier Flick, Molsheim (FR)

(21) Appl. No.: 19/138,491

(22) PCT Filed: Dec. 14, 2023
(86) PCT No.: PCT/EP2023/085860

§ 371 Date: Jun. 12, 2025

(30) Foreign Application Priority Data
Dec. 16, 2022 (EP) 22290076.3

(51) Int. Cl. B01D 63/08

(52) U.S. Cl. CPC B01D 63/082; B01D 2313/041; B01D 2313/105; B01D 2313/125; B01D 2313/21; B01D 2315/10

(57) ABSTRACT

A manifold assembly for tangential flow filtration includes a center manifold, at least one end cap, and at least one gasket disposed between the center manifold and the at least one end cap. The center manifold and the at least one end cap may be injection molded, and the at least one end cap may be removably coupled to the center manifold. At least one compression limiter may be at least partially captured within the center manifold, and at least one compression pin may be at least partially captured within the end cap. The combination of the at least one compression limiter and the at least one compression pin enable the manifold assembly to be clamped within a clamping arrangement. The center manifold may further include a feed port, a drain port, a retentate port, and a filtrate port that are disposed on the same side of the center manifold.

### CROSS-REFERENCE TO RELATED APPLICATIONS

This present application claims priority to European Patent Application No. 22290076.3, entitled “TANGENTIAL FLOW FILTRATION MANIFOLD ASSEMBLY,” and filed on Dec. 16, 2022, the disclosure of which is incorporated herein by reference in its entirety for all purposes.

### TECHNICAL FIELD

The present disclosure is directed generally toward tangential flow filtration devices, in particular, a manifold assembly that may be facilitate a tangential flow filtration operation.

### BACKGROUND OF THE INVENTION

The invention relates to a manifold assembly that may be utilized by a bioprocessing system for treatment of a biological liquid, particularly but not exclusively, for purifying a biopharmaceutical liquid in order to obtain products such as monoclonal antibodies, vaccines, and/or recombinant proteins.

It is known that biopharmaceutical liquids are, in general, obtained by culture in a bioreactor and that they must then be treated to achieve the required characteristics of purity, concentration, absence of viruses, etc.

The purification is carried out by means of a succession of treatments such as clarification, to eliminate the residues from the bioreactor culture, and viral filtration sometimes followed by diafiltration and concentration by tangential flow filtration via a filtration arrangement. Other operations exist concerning purification, such as chromatography.

Tangential flow filtration (TFF) is a separation process that uses membranes to separate components in a liquid solution or suspension on the basis of size or molecular weight differences. Applications include concentration, clarification, and desalting of proteins and other biomolecules such as nucleotides, antigens, and monoclonal antibodies; buffer exchange; process development; membrane selection studies; pre-chromatographic clarification to remove colloidal particles; depyrogenation of small molecules such as dextrose and antibiotics; harvesting, washing or clarification of cell cultures, lysates, colloidal suspensions and viral cultures; and sample preparation.

Conventional TFF devices that may be utilized by the bioprocessing system treating a biological liquid may be constructed by layering sheets of filtration membranes and woven screens, and may be contained in a cassette format. Conventionally, separate sealing gaskets may placed on both sides of the cassette and may be installed in the filtration arrangement between a manifold and holders (e.g., compression plates). The manifold serves to distribute the filtration fluid stream across the multiple flow paths within the TFF device. The TFF devices and gaskets are clamped between the manifold and holders, which operate cooperatively to impart the clamping force, in order to achieve the desired fluid sealing. In some other conventional TFF devices, the gaskets may be embedded in the TFF devices.

The conventional manifold of a typical filtration arrangement may be machined from stainless steel. This results in stainless steel manifolds that are expensive to manufacture and that cannot be gamma irradiated. Thus, stainless steel manifolds are more difficult and expensive to sterilize. In addition, stainless steel manifolds are not ergonomic due to their weight and due to the fluid ports being located on various sides of each stainless steel manifold. Because of the way in which stainless steel manifolds must be manufactured, stainless steel manifolds do not contain fluid ports that are all disposed on the same side. Therefore, the unergonomic nature of stainless steel manifolds makes them both difficult to handle and difficult to set up in a filtration arrangement of a bioprocessing system.

### SUMMARY OF THE INVENTION

The present disclosure is directed towards a manifold assembly for a tangential flow filtration assembly/arrangement that includes a center manifold, two end caps removably couplable to the center manifold (via snap fit arrangement or other known removably couplable fashion), and gaskets disposed between the center manifold and the end caps. The manifold assembly may be a single-use injection molded manifold assembly. More specifically, the center manifold and the end caps may be injection molded. In other embodiments, the center manifold and the end caps may be constructed via additive manufacturing techniques, including, but not limited to fused deposition modeling (FDM) 3D printing, selective laser sintering (SLS), digital light synthesis (DLS), etc. The center manifold may be formed or molded around one or more compression limiters such that the one or more compression limiters are at least partially captured within the center manifold. The end caps may be injection molded around one or more compression pins such that the one or more compression pins are at least partially captured within the end caps. In some additional embodiments, the one or more compression limiters and the one or more compression pins may be coupled to the center manifold and the end caps, respectively, via post molding operations, including, but not limited to, ultrasonic bonding, heat bonding, and/or other mechanical insertion methods. Constructing the center manifold and the end caps in this manner enables the manifold assembly disclosed herein to be lighter in weight than conventional stainless steel manifolds, while still being capable of withstanding the compressions forces applied to the manifold assembly by a compression mechanism of a filtration arrangement (i.e., due to the compression limiters and the compression pins). In addition, constructing the center manifold and the end caps in this manner may further enable the manifold assembly to be sterilized via any known sterilization methods, including, but not limited to, gamma irradiation, autoclaving, and other gas-or vapor-based sterilization methods, such as, but not limited to, ethylene oxide, chlorine dioxide, ozone, supercritical carbon dioxide, and vaporized hydrogen peroxide. Constructing the center manifold and the end caps in this manner also enables the various ports (e.g., feed port, drain port, retentate port, filtrate port, etc.) of the center manifold to all be disposed on the same side of the manifold assembly. This provides a more ergonomic manifold assembly for an operator to use and set up (i.e., connecting the tubing, etc.) in a clamping mechanism of a filtration arrangement. This further decreases the minimum working volume (MWV), which is key for TFF applications. Moreover, by constructing the manifold assembly from various components that are removably coupled to one another, individual components (e.g., the center manifold, the end caps, the gaskets, etc.) of the manifold assembly may be replaced if damaged instead of the entire manifold assembly.

In one embodiment, a manifold assembly for tangential flow filtration assembly that includes a manifold, a feed port, a retentate port, and a filtrate port. The manifold may have a first surface, a second surface opposite the first surface, a first edge spanning between the first surface and the second surface, and a second edge spanning between the first surface and the second surface, where the second edge is opposite the first edge. The feed port, the retentate port, and the filtrate port may all be disposed on the first edge of the manifold.

In some instances, the manifold assembly further includes an end cap. The end cap may be removably coupled to either the first surface or the second surface of the manifold. In some further instances, the manifold further comprises a first series of openings, a second series of openings, and a third series of openings. The first series of openings may be in fluid communication with the feed port. The second series of openings may be in fluid communication with the retentate port. The third series of openings may be in fluid communication with the filtrate port. In some even further instances, the end cap may include a fourth series of openings, a fifth series of openings, and a sixth series of openings. Each of the series of openings of the end cap may extend through the end cap. When the end cap is removably coupled to the manifold, the fourth series of openings of the end cap may be aligned with the first series of openings of the manifold, the fifth series of openings of the end cap may be aligned with the second series of openings of the manifold, and the sixth series of openings of the end cap may be aligned with the third series of openings of the manifold.

In another embodiment, a manifold assembly for tangential flow filtration assembly includes a manifold, a compression limiter, and an end cap. The manifold may have a first surface and a second surface opposite the first surface. The compression limiter may be at least partially captured within the manifold such that the compression limiter extends from the first surface to the second surface of the manifold. The end cap may be coupled to the first surface of the manifold.

In some instances, the manifold is injection molded or additively manufactured around the compression limiter. In some additional instances, the end cap may include an outer surface and an opposite inner surface. In some further instances, the manifold assembly further includes a compression pin at least partially captured within the end cap such that a portion of the compression pin extends from the inner surface of the end cap. In even some further instances, when the end cap is coupled to the manifold, the compression pin may be aligned with the compression limiter.

In some additional instances, the compression limiter may be a cylinder having a conduit. Moreover, when the end cap is coupled to the manifold, the compression pin may abut against an end of the compression limiter and the portion of the compression pin may be disposed within the conduit of the compression limiter. The end cap and the manifold may have a first durometer value, while the compression limiter and the compression pin may have a second durometer value that is greater than the first durometer value.

In yet another embodiment, a manifold assembly for a tangential flow filtration assembly may include a manifold and an end cap. The manifold may have a first surface, a second surface opposite the first surface, and a plurality of ports extending from a first edge of the manifold. The manifold may further have a plurality of first openings extending into the manifold on the first surface, where the plurality of first openings may be in fluid communication with the plurality of ports. The end cap may have an inner surface, an outer surface, and a plurality of second openings extending through the end cap from the inner surface to the outer surface. In addition, the plurality of second openings may be aligned with the plurality of first openings when the end cap is coupled to the first surface the manifold.

In some instances, the inner surface of the end cap may be disposed more proximate to the first surface of the manifold than the outer surface of the end cap when the end cap is coupled to the manifold. In some even further instances, the manifold assembly may also include at least one gasket disposed between the first surface of the manifold and the inner surface of the end cap.

In still some further instances, the manifold may further have a plurality of first pathways disposed on the first surface, and the end cap may further have a plurality of second pathways disposed on the inner surface. When the end cap is coupled to the manifold, the plurality of first pathways and the plurality of second pathways may collectively form a passageway through at least a portion of the manifold assembly.

Other systems, devices, apparatuses, methods, features, and advantages will be, or will become, apparent to one with skill in the art upon examination of the following figures and detailed description. All such additional systems, devices, arrangements, mechanisms, assemblies, apparatuses, methods, features, and advantages are included within this description, are within the scope of the claimed subject matter.

### BRIEF DESCRIPTION OF THE DRAWINGS

The apparatuses, systems, assemblies, devices, components, cassettes, plates, manifolds, end caps, gaskets, limiters, pins, pathways, and passageways, presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1 illustrates a perspective/front view of a bioprocessing system that contains a filtration arrangement that utilizes a manifold assembly, according to an example embodiment of the present disclosure.

FIG. 2 illustrates a perspective of the filtration arrangement of the bioprocessing system illustrated in FIG. 1, the filtration arrangement containing a manifold assembly in accordance with an example embodiment of the present disclosure.

FIG. 3 illustrates a perspective view of a manifold assembly of the filtration arrangement illustrated in FIG. 2 and in accordance with an example embodiment of the present disclosure.

FIG. 4 illustrates an exploded view of the manifold assembly illustrated in FIG. 3.

FIG. 5A illustrates a perspective view of a manifold of the manifold assembly illustrated in FIG. 3.

FIG. 5B illustrates a side view of the manifold illustrated in FIG. 5A.

FIG. 6A illustrates a perspective view of an outer surface of an end cap of the manifold assembly illustrated in FIG. 3.

FIG. 6B illustrates a perspective view of an inner surface of the end cap illustrated in FIG. 6A.

FIG. 6C illustrates a cross-sectional view of the end cap illustrated in FIG. 6A, the cross-section being taken along line 6C-6C of FIG. 6A.

FIG. 7 illustrates a perspective view of a compression pin of the end cap illustrated in FIG. 6A.

FIG. 8 illustrates a perspective view of a compression limiter of the manifold illustrated in FIG. 5A.

FIG. 9A illustrates a perspective view of the interaction and compression between two of the compression pins illustrated in FIG. 7 and the compression limiter illustrated in FIG. 8.

FIG. 9B illustrates a cross-sectional view of the interaction and compression between the two compression pins and the compression limiter illustrated in FIG. 9A, the cross-section being taken along line 9B-9B of FIG. 9A.

FIG. 9C illustrates a cross-sectional view of the manifold assembly illustrated in FIG. 3 and depicting a compression pin of each end cap, like that illustrated in FIG. 6A, of the manifold assembly abutting against a compression limiter of the manifold illustrated in FIG. 5A, the cross-section being taken along line 9C-9C in FIG. 3.

FIG. 10 illustrates a perspective view of an upper gasket of the manifold assembly illustrated in FIG. 3.

FIG. 11 illustrates a perspective view of a lower gasket of the manifold assembly illustrated in FIG. 3.

FIG. 12A illustrates a perspective view of the manifold illustrated in FIG. 5A and the location and arrangement of the upper gasket and lower gasket with respect to a first side of the manifold.

FIG. 12B illustrates a perspective view of the end cap illustrated in FIG. 6A and the location and arrangement of the upper gasket and lower gasket with respect to the inner surface of the end cap.

FIG. 13 illustrates a cross-sectional view of the feed port and feed conduit of the manifold assembly illustrated in FIG. 3, the cross-section being taken along line 13-13 in FIG. 3.

FIG. 14 illustrates a cross-sectional view of the drain port and drain conduit of the manifold assembly illustrated in FIG. 3, the cross-section being taken along line 14-14 in FIG. 3.

FIG. 15 illustrates a cross-sectional view of the manifold assembly illustrated in FIG. 3, the cross-section being taken along line 15-15 in FIG. 3.

FIG. 16 illustrates a cross-sectional view of the filtrate port and filtrate conduit of the manifold assembly illustrated in FIG. 3, the cross-section being taken along line 16-16 in FIG. 3.

FIG. 17 illustrates a cross-sectional view of the retentate port and retentate conduit of the manifold assembly illustrated in FIG. 3, the cross-section being taken along line 17-17 in FIG. 3.

### DETAILED DESCRIPTION OF THE INVENTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment,” “an embodiment,” “an exemplary embodiment,” and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

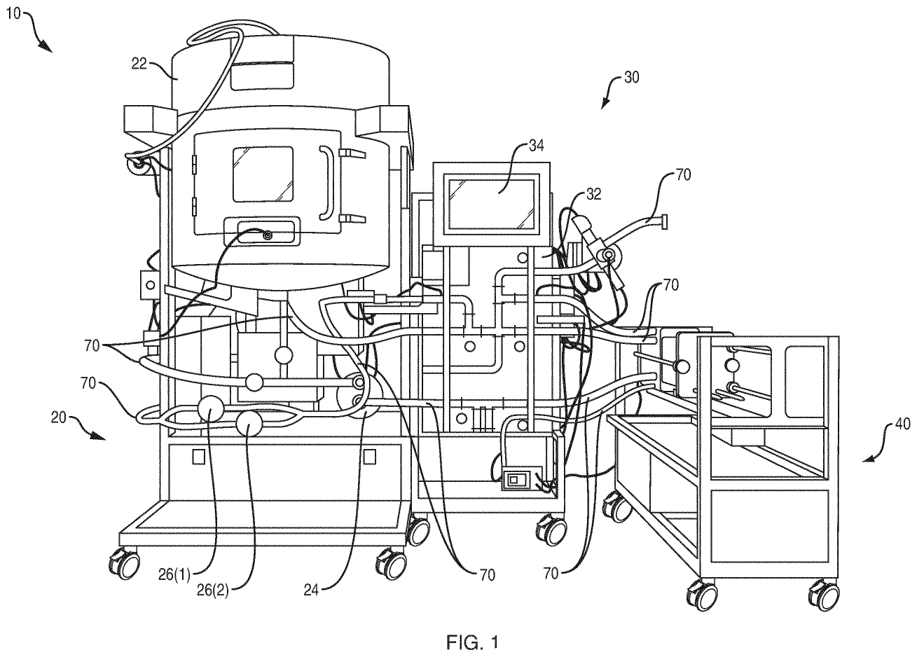

Turning to FIG. 1, illustrated is a bioprocessing system 10 configured to treat a biological liquid. The bioprocessing system 10 may be configured to, but not limited exclusively to, purify a biopharmaceutical liquid in order to obtain products such as monoclonal antibodies, vaccines, or recombinant proteins. The bioprocessing system 10 may include a tank cart 20, a treatment cart 30, and a filtration arrangement 40. The tank cart 20 may include a feed tank or recycle tank 22, at least one feed pump 24, and at least one transfer pump 26. In the illustrated embodiment, the tank cart 20 includes a single feed pump 24 and two transfer pumps 26(1), 26(2). The feed tank 22 may be configured to house a biological liquid that is to be treated by the bioprocessing system 10, and, in some instances, may include a mixer (not shown). The feed pump 24 may be configured to pump the biological liquid from the feed tank 22 to the treatment cart 30, and, ultimately, through the filtration arrangement 40. The transfer pumps 26(1), 26(2) may be configured to pump reagents and solutions to the treatment cart 30 in order to introduce the reagents and solutions to the biological liquid. The feed pump 24 and the transfer pumps 26(1), 26(2) may be any type of pump suitable for the bioprocessing system 10, including, but not limited to, low shear diaphragm pumps.

Continuing with FIG. 1, the treatment cart 30 is configured to be disposed adjacent or in abutment with the tank cart 20, and may be configured to support a treatment device 32. The treatment device 32 may contain a series of valves that may, depending on the operation, dictate flow paths to deliver the biological fluid from the feed tank 22 to the filtration arrangement 40, and extract from the filtration arrangement 40 the filtrate, retentate, and drain of the biological fluid. The treatment device 32 may further dictate the flow paths to deliver the filtrate, retentate, and drain to their respective destinations (e.g., feed tank 22, other storage device, etc.), and to introduce/mix the reagents and solutions to the biological liquid. The treatment device 32 may include a controller 34 that is configured to control the valves of the treatment device 32.

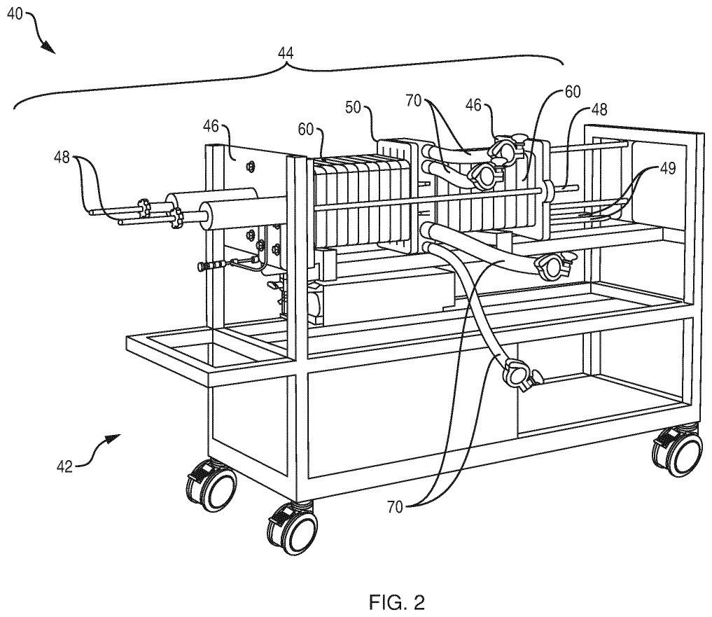

As best illustrated in FIGS. 1 and 2, the filtration arrangement 40 includes a filtration cart 42 that may be positioned adjacent (e.g., in proximity to) or in abutment with the tank cart 20 and/or the treatment cart 30. The filtration cart 42 may further include a clamping mechanism 44 that may include one or more clamping plates 46 that are movably disposed on clamping rails 48 and reference rods 49. As further illustrated in FIG. 2, the filtration arrangement 40 may further include a manifold assembly 50 that may be disposed on the clamping mechanism 44. As explained in further detail below, the manifold assembly 50 may be configured to receive at least one of the reference rods 49 in order to facilitate the position and orientation of the manifold assembly 50 on the clamping mechanism 44. The filtration arrangement 44 may also include any number of filtration cassettes 60, which may be used to filter the biological liquid via a TFF process. As illustrated in FIG. 2, the filtration cassettes 60 may be disposed between the manifold assembly 50 and a clamping plate 46 of the clamping mechanism 44. The clamping mechanism 44 may be configured to clamp one or more filtration cassettes 60 against one side of the manifold assembly 50. In some embodiments, like that illustrated in FIG. 2, the manifold assembly may be a central manifold assembly 50 where the filtration cassettes 60 are disposed on two sides of the manifold assembly 50. In other words, the central manifold assembly 50 may be sandwiched between filtration cassettes 60, which are further sandwiched between the clamping plates 46 of the clamping mechanism 44. Once arranged properly, the manifold assembly 50 may be configured to deliver a biological liquid from the treatment device 32 to the filtration cassettes 60, and from the filtration cassettes 60 back to the treatment device 32.

Continuing with FIGS. 1 and 2, tubing 70 may connect the various components of the bioprocessing system 10 to one another. Thus, tubing 70 may connect the feed tank 22 to the feed pump 24, and may connect the feed pump 24 to the treatment device 32. The tubing 70 may further connect the treatment device 32 and the manifold assembly 50 of the filtration arrangement 40 to one another. As further illustrated, the tubing 70 may further connect the treatment device 32 to the transfer pumps 26(1), 26(2), and directly to the feed tank 22. In addition, the tubing 70 may connect the transfer pumps 26(1), 26(2) to the reagent and solution sources, as well as connect the treatment device 32 to the various storage devices for the filtrate and drain of the biological liquid.

FIG. 1 illustrates an example embodiment of a bioprocessing system 10 that may be utilized to treat a biological liquid, but the illustrated example embodiment is not intended to be limited to the details shown and described above. It will be apparent that various modifications and structural changes may be made to the bioprocessing system 10 depending on the type of treatment to be performed on the biological liquid. In addition, FIG. 2 illustrates an example embodiment of a filtration arrangement 40 that may be utilized by the bioprocessing system 10, and that is configured to utilize the manifold assembly 50 described in further details below. The illustrated example embodiment of the filtration arrangement 40 is not intended to be limited to the details shown and described above. It will be apparent that various modifications and structural changes may be made to the filtration arrangement 44 depending on the type of treatment to be performed on the biological liquid and so long as the filtration arrangement 44 may utilize the manifold assembly 50 described herein.

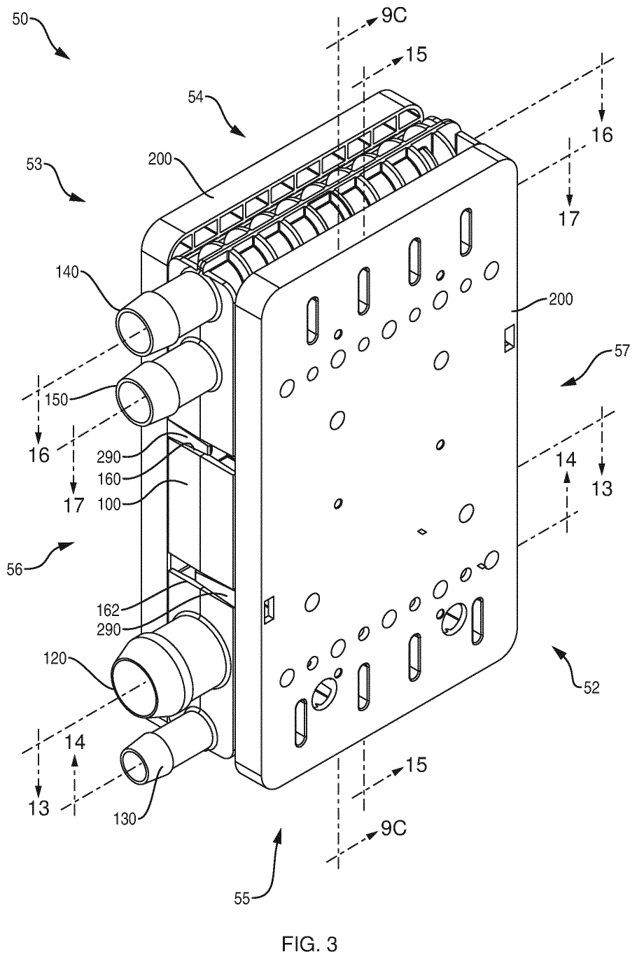

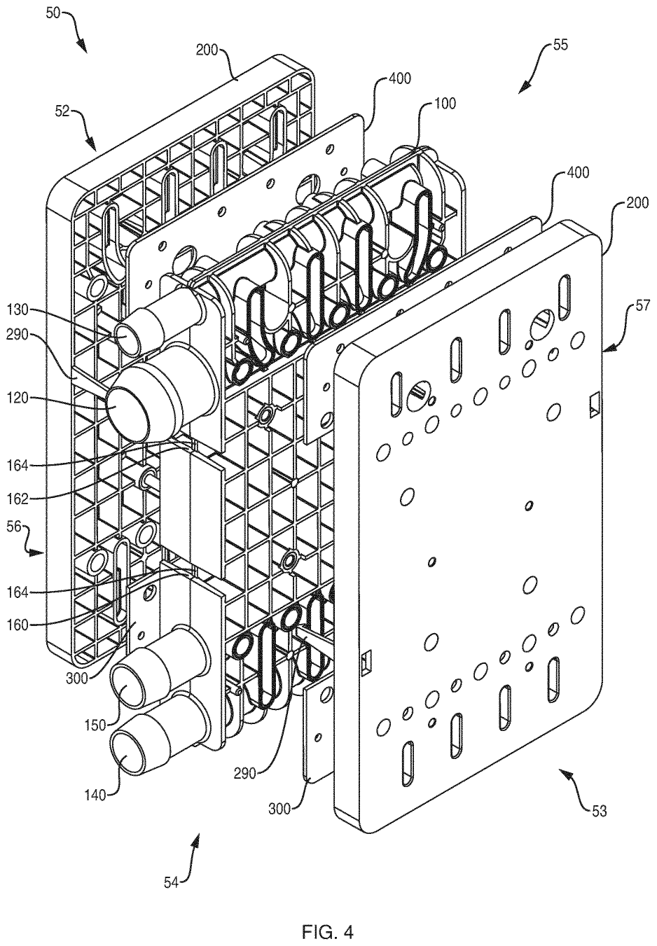

Turning to FIGS. 3 and 4, illustrated is an embodiment of a single use manifold assembly 50 to be utilized in the filtration arrangement 40 of the bioprocessing system 10. The illustrated embodiment of the manifold assembly 50 is a central manifold assembly 50, which, as explained above, enables filtration cassettes 60 to be located on opposing sides of the manifold assembly 50. As explained in more detail below, several components of the manifold assembly 50 that is illustrated in FIGS. 3 and 4 may be injection molded or constructed via additive manufacturing processes, including, but not limited to, fused deposition modeling (FDM) 3D printing, selective laser sintering (SLS), digital light synthesis (DLS), etc.

The manifold assembly 50 may include a first side 52, an opposite second side 53, a top end 54 spanning between the first side 52 and the second side 53, and a bottom end 55 opposite the top end 54 that also spans between the first side 52 and the second side 53. The manifold assembly 50 may further include a first elongated end 56 that spans between the first side 52, the second side 53, the top end 54, and the bottom end 55, as well as a second elongated end 57 opposite the first elongated end 56. The second elongated end 57 may also span between the first side 52, the second side 53, the top end 54, and the bottom end 55. Thus, the manifold assembly 50 may have a substantially rectangular prismatic shape.

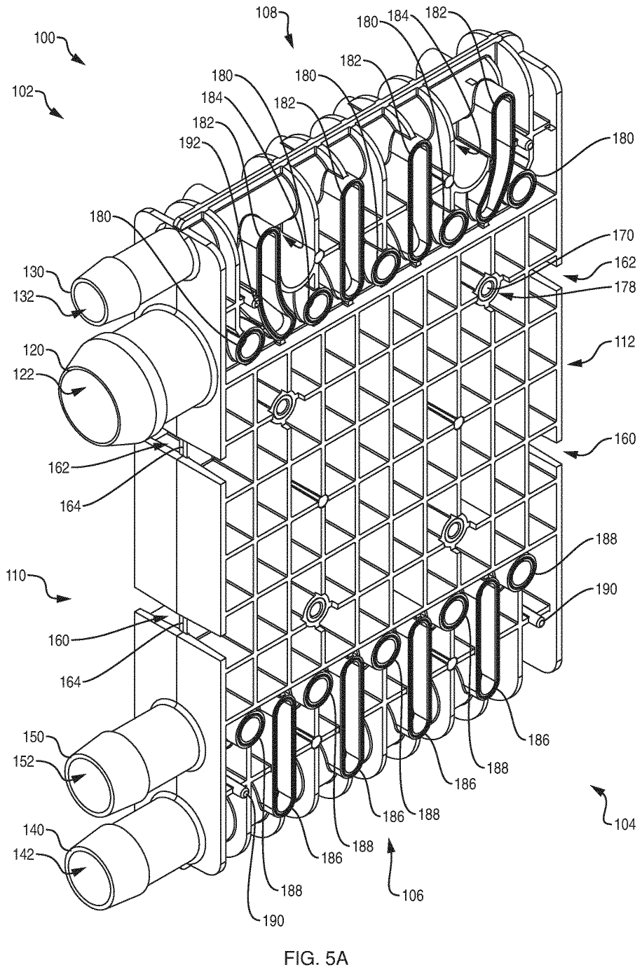

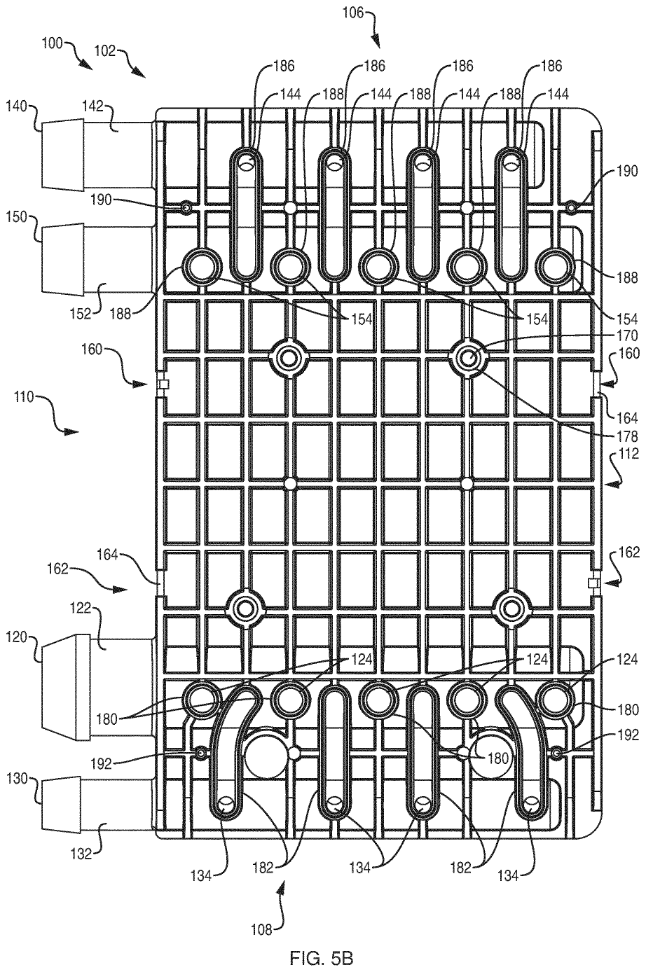

As best illustrated in FIG. 4, the manifold assembly 50 may include a center manifold 100, two end caps 200, two upper gaskets 300, and two lower gaskets 400. The center manifold 100 is best illustrated in FIGS. 4, 5A, and 5B, where the center manifold 100 is depicted in FIGS. 5A and 5B as being isolated from the end caps 200 and gaskets 300, 400. The center manifold 100 may be constructed via an injection molding process, and may be formed from any number of materials configured to be utilized in an injection molding process. These materials include plastics and thermoplastics such as, but not limited to, acrylic, acrylonitrile butadiene styrene, nylon, polycarbonate, polyethylene, polyoxymethylene, polypropylene, thermoplastic elastomer, thermoplastic polyurethane, silicone, and polysulfone. In some embodiments, the center manifold 100 may be formed from polysulfone reinforced with 30% glass fibers. Thus, the center manifold 100 may have a durometer hardness value in the approximate range of 80 to 90 on the Rockwell M scale. In some embodiments, the center manifold 100 may be constructed via additive manufacturing techniques, including, but not limited to fused deposition modeling (FDM) 3D printing, selective laser sintering (SLS), digital light synthesis (DLS), etc. While FIG. 5B illustrates a side elevational view of the first side 102 of the center manifold 100, it should be understood that the second side 104 of the center manifold 100 may be substantially identical, but mirrored, from that of the first side 102 of the center manifold 100. Thus, any depiction and/or description with regard to the first side 102 of the center manifold 100 also applies to the second side 104 of the center manifold 100.

The center manifold 100 may have a substantially rectangular prismatic shape, like that of the manifold assembly 50, and has a first side 102 and an opposite second side 104. The center manifold 100 further includes a top end 106 spanning between the first side 102 and the second side 104, an opposite bottom end 108 that also spans between the first side 102 and the second side 104, and first and second elongated ends 110, 112 that are opposite of one another. The first elongated end 110 and the second elongated end 112 may each span between the first side 102, the second side 104, the top end 106, and the bottom end 108. The first elongated end 110 of the center manifold 100 may form at least a portion of the first elongated end 56 of the manifold assembly 50, while the second elongated end 112 of the center manifold 100 may form at least a portion of the second elongated end 57 of the manifold assembly 50. In addition, the top end 106 of the center manifold 100 may form at least a portion of the top end 54 of the manifold assembly 50, while the bottom end 108 of the center manifold 100 may form at least a portion of the bottom end 55 of the manifold assembly 50.

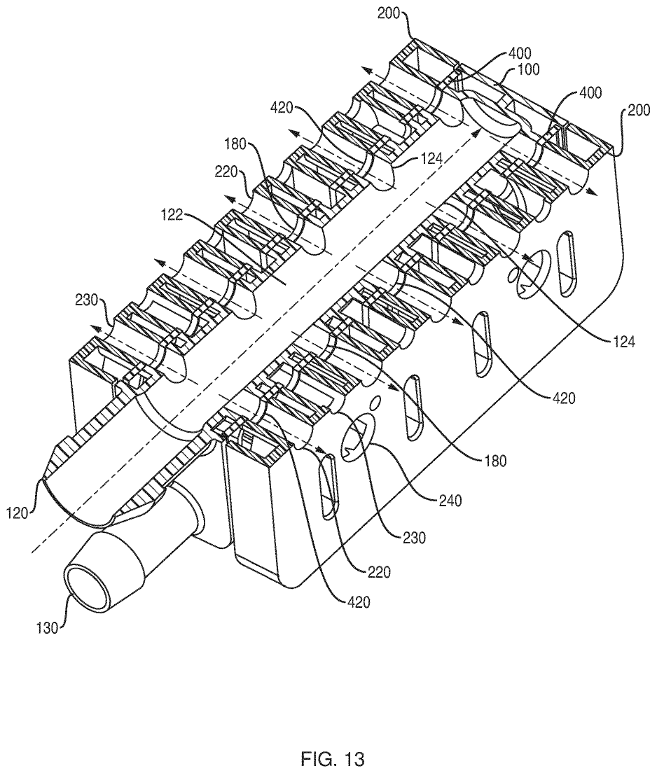

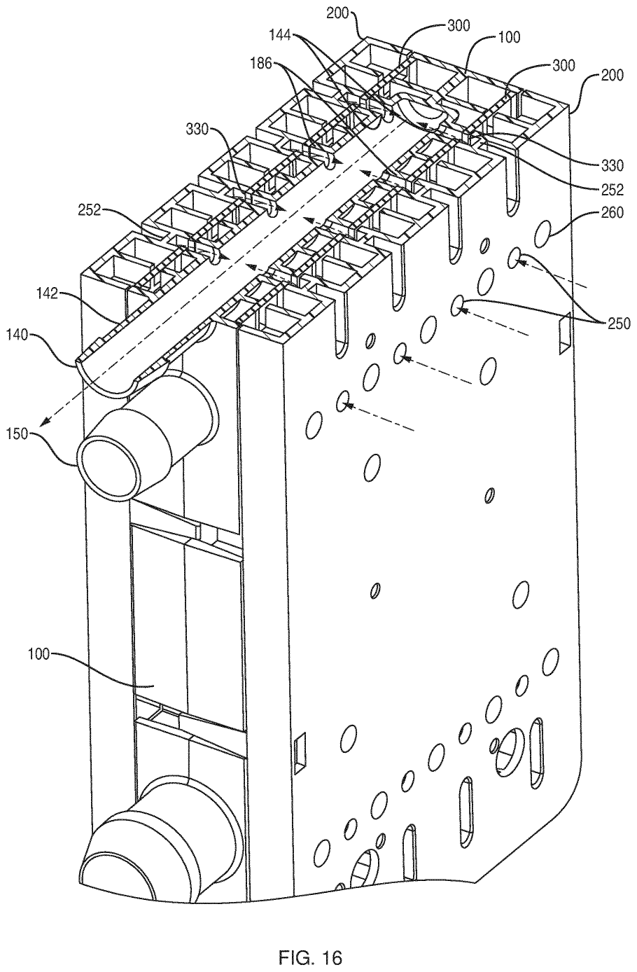

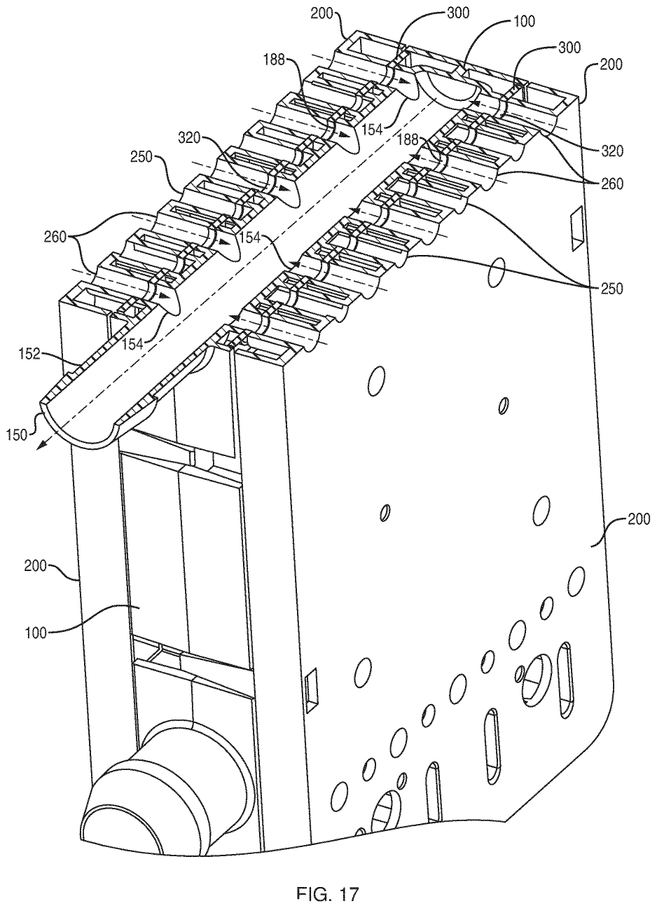

The illustrated center manifold 100 may include a feed port 120, a drain port 130 (i.e., lower filtrate port), a filtrate port 140 (i.e., upper filtrate port), and a retentate port 150 all disposed on the first elongated end 110. Thus, the feed port 120, drain port 130, filtrate port 140, and retentate port 150 are all disposed on the same side/end of the center manifold 100. With the ports 120, 130, 140, 150 being disposed on the same side/end of the center manifold 100, it then follows that, as best illustrated in FIG. 3, the ports 120, 130, 140, 150 are disposed on the same side/end of the manifold assembly 50. The feed port 120 may serve, in some embodiments, as an inlet to the center manifold 100. The feed port 120 may contain a feed conduit 122 and a series of feed outlets 124 equally spaced along the feed conduit 122 such that the feed outlets 124 are oriented on the first side 102 and the second side 104 of the center manifold 100 (best illustrated in FIGS. 5B and 13). The drain port 130, the filtrate port 140, and the retentate port 150 may serve, in some embodiments, as outlets to the center manifold 100. The drain port 130 may also contain a drain conduit 132 and a series of drain inlets 134 equally spaced along the drain conduit 132 such that the drain inlets 134 are oriented on the first side 102 and the second side 104 of the center manifold 100 (best illustrated in FIGS. 5B, 14, and 15). Like the drain port 130, the filtrate port 140 and the retentate port 150 each contain a conduit 142, 152, respectively. The filtrate conduit 142 of the filtrate port 140 may include a series of filtrate inlets 144 that are spaced along the filtrate conduit 142 such that the filtrate inlets 144 are oriented on the first and second sides 102, 104 of the center manifold 100 (best illustrated in FIGS. 5B and 17). Similarly, the retentate conduit 152 of the retentate port 150 may include a series of retentate inlets 154 that are spaced along the retentate conduit 152 such that the retentate inlets 154 are oriented on the first and second sides 102, 104 of the center manifold 100 (best illustrated in FIGS. 5B and 16).

The first elongated end 110 further includes an upper slot 160 and a lower slot 162. The upper and lower slots 160, 162 span across the first elongated end 110 from the first side 102 to the second side 104, and may be disposed between the feed port 120 and the retentate port 150. As further illustrated, the upper slot 160 may be spaced from the lower slot 162 such that the upper slot 160 is disposed on the first elongated end 110 more proximate to the top end 106 than the bottom end 108, while the lower slot 162 may be disposed on the first elongated end 110 more proximate to the bottom end 108 than the top end 106. Thus, upper slot 160 may be disposed above the midpoint of the first elongated end 110, and the lower slot 162 may be disposed below the midpoint of the first elongated end 110. Disposed in each of the upper and lower slots 160, 162 may be an engagement flange 164. The engagement flange 164 may be oriented transverse to the length of the upper and lower slots 160, 162, and may be disposed within the slots 160, 162 equidistant from the first and second sides 102, 104 of the center manifold 100. The second elongated end 112 may also include upper and lower slots 160, 162 that each contain an engagement flange 164 like that of the first elongated end 110.

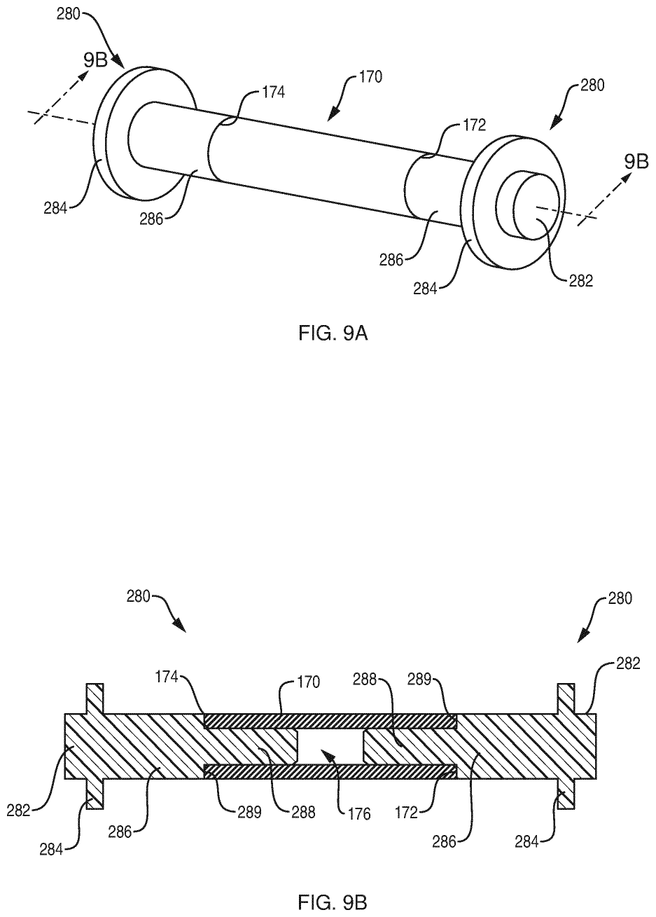

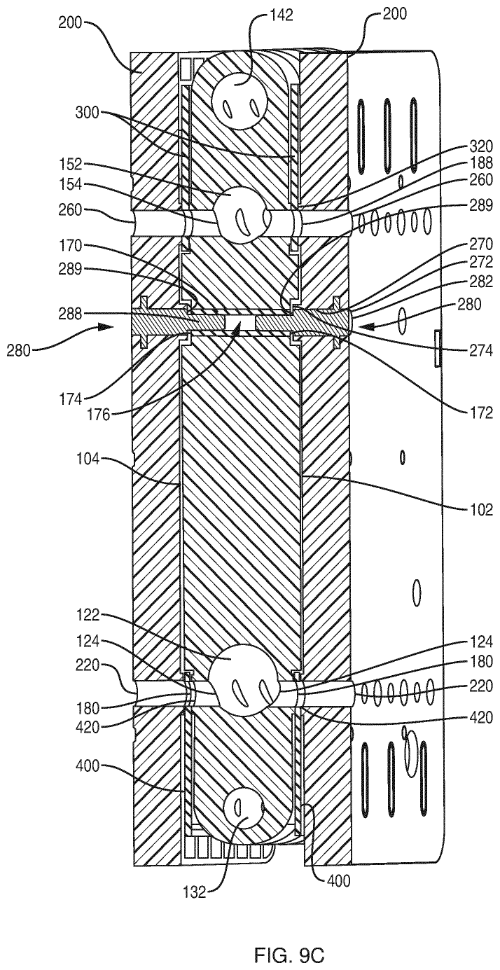

Continuing with FIGS. 5A and 5B, and with further reference to FIG. 8, the center manifold 100 may include a series of compression limiters 170 that are disposed within compression limiter apertures 178. FIG. 8 illustrates an example embodiment of a compression limiter 170. As illustrated, the compression limiters 170 may be substantially cylindrical in shape, and having a first end 172, a second end 174, and a conduit 176 spanning through the compression limiter 170 from the first end 172 to the second end 174. In other embodiments the compression limiters 170 may be of any other shape. Each of the compression limiter apertures 178 extend through the center manifold 100 from the first side 102 to the second side 104 of the center manifold 100. In then follows that the compression limiters 170 extend through the compression limiter apertures 178 from the first side 102 of the center manifold 100 to the second side 104 of the center manifold 100. Thus, the first end 172 of the compression limiter 170 may be disposed on the first side 102 of the center manifold 100, while the second end 174 of the compression limiter 170 may be disposed on the second side 104 of the center manifold (as best illustrated in FIG. 9C). The compression limiters 170 may be constructed from any metallic material, plastic material, or other material configured to withstand compression forces of at least approximately five (5) tons. In some embodiments, the compression limiters 170 may be formed from a stainless steel, including, but not limited to, SAE 316L stainless steel. Thus, the compression limiters 170 may have a durometer hardness value in the approximate range of 75 to 95 on the Rockwell B scale. When constructing the center manifold 100, the center manifold 100 may be injection molded or additively manufactured around the compression limiters 170 to at least partially capture the compression limiters 170 within the compression limiter apertures 178. In some additional embodiments, the compression limiters 170 may be coupled to the center manifold 100 via post molding operations, including, but not limited to, ultrasonic bonding, heat bonding, and/or other mechanical insertion methods.

With further reference to FIGS. 5A and 5B, the first side 102 of the center manifold 100 includes a series of feed openings 180 and drain pathways 182 that are disposed more proximate to the bottom end 108 of the center manifold 100 than the top end 106 of the center manifold 100. The feed openings 180 may be substantially circular openings, while the drain pathways 182 may be elongated stadium or capsule shaped openings. The feed openings 180 and the top ends of the drain pathways 182 may be horizontally aligned with one another such that the feed openings 180 and the drain pathways 182 span across the lower portion of the first side 102 of the center manifold 100 from the first elongated end 110 to the second elongated end 112 in an alternating fashion. In other words, a portion (i.e., the top end) of each drain pathway 182 may be disposed between two feed openings 180. Moreover, the two outermost drain pathways 182 may be curved, while the two innermost drain pathways 182 may be substantially vertical. Despite the outermost drain pathways 182 being curved, all of the drain pathways 182 may be elongated in the substantially vertical direction. Moreover, the two outermost drain pathways 182 may be curved to extend around the two reference rod openings 184 that are disposed below the feed openings 180. The two reference rod openings 184 may be configured to receive the reference rods 49 of the clamping mechanism 44 of the filtration arrangement 40, like that illustrated in FIG. 2. As best illustrated in FIG. 5B, the feed openings 180 may be aligned with the feed outlets 124 of the feed conduit 122 of the feed port 120. Furthermore, the bottom ends of the drain pathways 182 may be aligned with the drain inlets 134 of the drain conduit 132 of the drain port 130.

Continuing with FIGS. 5A and 5B, the first side 102 of the center manifold 100 further includes a series of filtrate pathways 186 and retentate openings 188 that are disposed more proximate to the top end 106 of the center manifold 100 than the bottom end 108 of the center manifold 100. The filtrate pathways 186 may be elongated stadium or capsule shaped openings, while the retentate openings 188 may be substantially circular openings. The filtrate pathways 186 may be elongated in the substantially vertical direction. The retentate openings 188 and the bottom ends of the filtrate pathways 186 may be horizontally aligned with one another such that the retentate openings 188 and the filtrate pathways 186 span across the upper portion of the first side 102 of the center manifold 100 from the first elongated end 110 to the second elongated end 112 in an alternating fashion. In other words, a portion (i.e., the bottom end) of each filtrate pathway 186 may be disposed between two retentate openings 188. As best illustrated in FIG. 5B, the retentate openings 188 may be aligned with the retentate inlets 154 of the retentate conduit 152 of the retentate port 150. Furthermore, the top ends of the filtrate pathways 186 may be aligned with the filtrate inlets 144 of the filtrate conduit 142 of the filtrate port 140.

As further illustrated in FIGS. 5A and 5B, the first side 102 of the center manifold 100 may include upper gasket alignment projections 190 and lower gasket alignment projection 192. The upper gasket alignment projections 190 may be disposed in proximity to the filtrate pathways 186 and the retentate openings 188, while the lower gasket alignment projections 192 may be disposed in proximity to the feed openings 180 and the drain pathways 182. More specifically, the upper gasket alignment projections 190 may include two projections, one disposed proximate to the first elongated end 110 and the second disposed proximate to the second elongated end 112. In addition, the upper gasket alignment projections 190 may be disposed above the retentate openings 188 and the bottom ends of the filtrate pathways 186, but below the upper ends of the filtrate pathways 186. Like the upper gasket alignment projections 190, the lower gasket alignment projections 192 may also include two projections, one disposed proximate to the first elongated end 110 and the second disposed proximate to the second elongated end 112. The lower gasket alignment projections 192 may further be disposed below the feed openings 180 and the upper ends of the drain pathways 182, while being disposed above the lower ends of the drain pathways 182.

While FIGS. 5A and 5B illustrate the first side 102 of the center manifold 100, it should be understood that the second side 104 of the center manifold 100 may be substantially identical, but mirrored, from that of the first side 102 of the center manifold 100. Thus, any depiction and/or description with regard to the first side 102 of the center manifold 100 also applies to the second side 104 of the center manifold 100

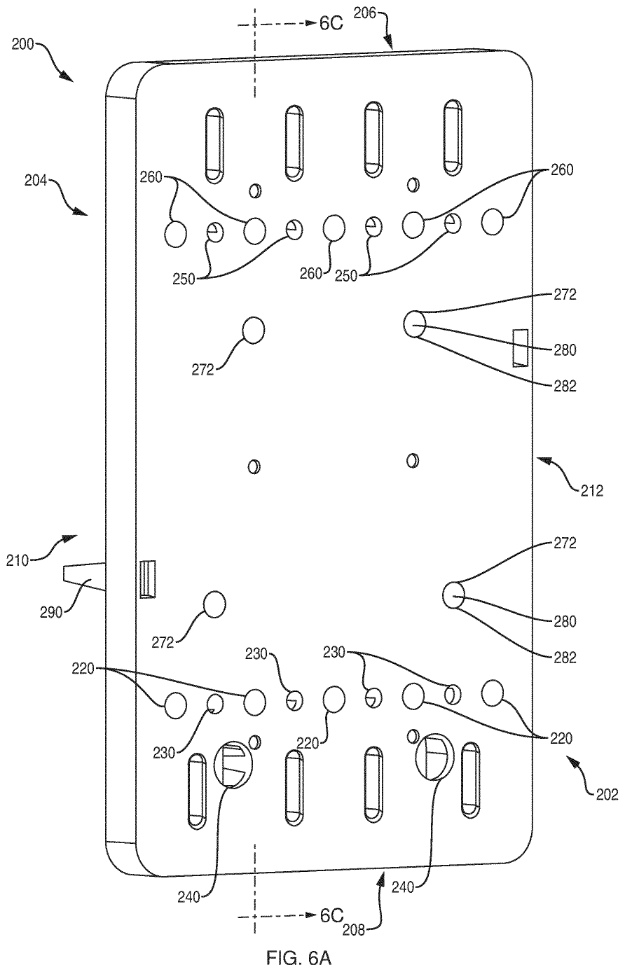

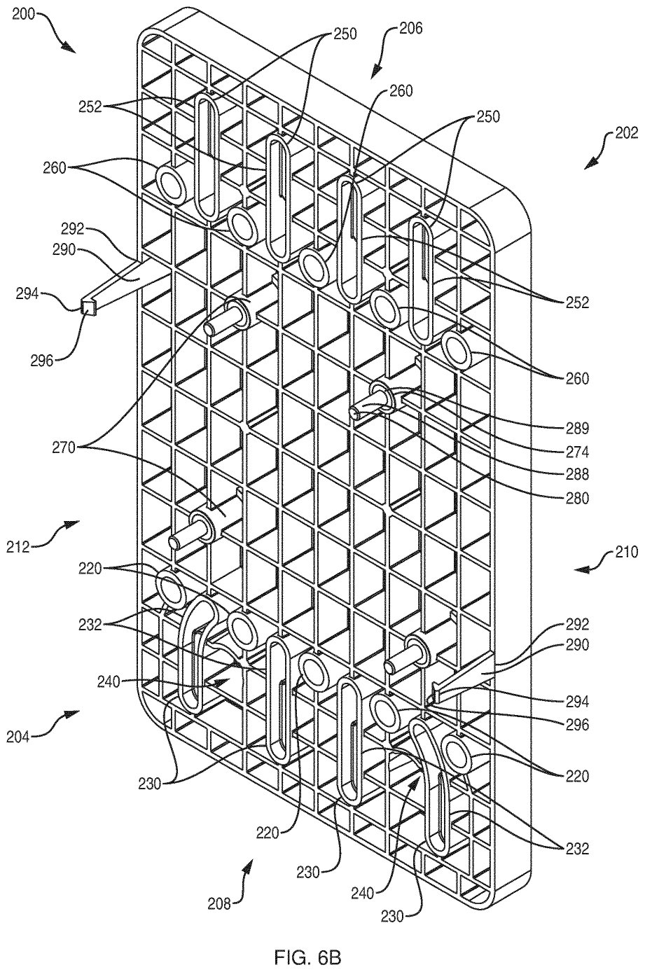

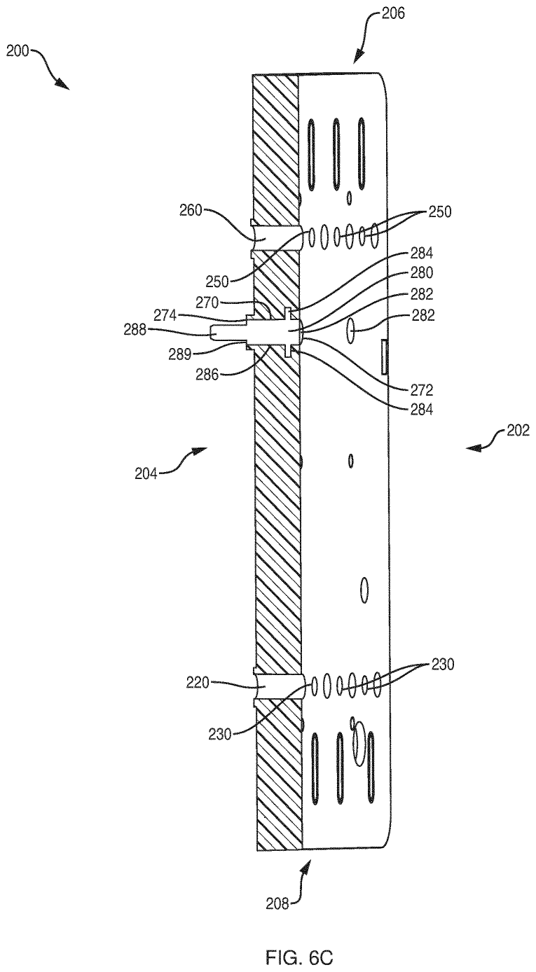

Turning to FIGS. 6A-6C, illustrated is an embodiment of an end cap 200 of the manifold assembly 50. As previously explained, the manifold assembly 50 may include more than one end cap 200, and each of the end caps 200 of the manifold assembly 50 may be substantially identical to one another. Thus, while FIGS. 6A-6C illustrate a single end cap 200 of the manifold assembly 50, it should be understood that any depiction and/or description with regard to the end cap 200 may also apply to the other end caps 200 of the manifold assembly 50. Like the center manifold 100, the end caps 200 may be constructed via an injection molding process, and may be formed from any number of materials configured to be utilized in an injection molding process. These materials include plastics and thermoplastics such as, but not limited to, acrylic, acrylonitrile butadiene styrene, nylon, polycarbonate, polyethylene, polyoxymethylene, polypropylene, thermoplastic elastomer, thermoplastic polyurethane, silicone, and polysulfone. In some embodiments, the end caps 200 may be formed from polysulfone reinforced with 30% glass fibers. Thus, the end caps 200 may have a durometer hardness value in the approximate range of 80 to 90 on the Rockwell M scale. In some embodiments, the center manifold 100 may be constructed via additive manufacturing techniques, including, but not limited to fused deposition modeling (FDM) 3D printing, selective laser sintering (SLS), digital light synthesis (DLS), etc.

The end cap 200 illustrated in FIGS. 6A-6B may include an outer surface 202, an inner surface 204 opposite the outer surface 202, a top end 206 spanning between the outer surface 202 and the inner surface 204, and a bottom end 208 opposite the top end 206 and also spanning between the outer surface 202 and the inner surface 204. The end cap 200 may further include a first side end 210 and an opposite second side end 212. The first and second side ends 210, 212 may span between the outer surface 202, the inner surface 204, the top end 206 and the bottom end 208. Thus, the end cap 200 may have a substantially rectangular prismatic shape.

As best illustrated in FIGS. 6A and 6B, the end cap 200 may include a series of feed openings 220 and a series of drain openings 230. The feed openings 220 and the drain openings 230 may span from the outer surface 202, through the end cap 200, to the inner surface 204. FIG. 6A illustrates that the feed openings 220 and the drain openings 230 may be substantially circular openings on the outer surface 202 of the end cap 200. As illustrated, the feed openings 220 may be larger in diameter than the drain openings 230. Moreover, the feed openings 220 and the drain openings 230 may be horizontally aligned with one another such that the feed openings 220 and the drain openings 230 span across the lower portion of the end cap 200 from the first side end 210 to the second side end 212 in an alternating fashion. In other words, each drain opening 230 may be disposed between two feed openings 220. As further illustrated in FIG. 6B, the feed openings 220 may also be substantially cylindrically shaped on the inner surface 204 of the end cap 200, while, conversely, the drain openings 230 may have an elongated stadium or capsule shape. Thus, each of the drain openings 230 may define, along the inner surface 204 of the end cap 200, an elongated inner surface pathway 232. As illustrated, the elongated inner surface pathways 232 of the drain openings 230 may extend downward in a substantially vertical direction from the horizontal plane in which the feed openings 220 are disposed. Like the drain pathways 182 of the center manifold 100, the two outermost elongated inner surface pathways 232 may be curved, while the two innermost elongated inner surface pathways 232 may be substantially vertical. The two outermost elongated inner surface pathways 232 may be curved to extend around the two reference rod openings 240 that are disposed below the feed openings 220. The two reference rod openings 240 may be configured to receive the reference rods 49 of the clamping mechanism 44 of the filtration arrangement 40, like that illustrated in FIG. 2.

Continuing with FIGS. 6A and 6B, the end cap 200 may further include a series of filtrate openings 250 and a series of retentate openings 260. The filtrate openings 250 and the retentate openings 260 may also span from the outer surface 202, through the end cap 200, to the inner surface 204. FIG. 6A illustrates that the filtrate openings 250 and the retentate openings 260 may be substantially circular openings on the outer surface 202 of the end cap 200. In the illustrated embodiment, the retentate openings 260 may be larger in diameter than the filtrate openings 250. Moreover, the filtrate openings 250 and the retentate openings 260 may be horizontally aligned with one another such that the filtrate openings 250 and the retentate openings 260 span across the lower portion of the end cap 200 from the first side end 210 to the second side end 212 in an alternating fashion. In other words, each filtrate opening 250 may be disposed between two retentate openings 260. As further illustrated in FIG. 6B, the retentate openings 260 may also be substantially cylindrically shaped on the inner surface 204 of the end cap 200, while, conversely, the filtrate openings 250 may have an elongated stadium or capsule shape. Thus, each of the filtrate openings 250 may define, along the inner surface 204 of the end cap 200, an elongated inner surface pathway 252 that extends upward, in a substantially vertical direction, from the horizontal plane in which the retentate openings 260 are disposed.

Continuing with FIGS. 6A-6C, the end cap 200 further includes a series of compression pin housings 270 that are each accessible via an outer compression pin opening 272 and an inner compression pin opening 274. The outer compression pin openings 272 are disposed on the outer surface 202 of the end cap 200, while the inner compression pin openings 274 are disposed on the inner surface 204 of the end cap 200. Thus, the compression pin housings 270 extend from the outer surface 202 of the end cap 200 to the inner surface 204 of the end cap 200. The compression pin housings 270 may be primarily disposed between the grouping of the feed openings 220 and the drain openings 230 and the grouping of the filtrate openings 250 and the retentate openings 260. In the illustrated embodiment, the compression pin housings 270 may be grouped into a first pair of compression pin housings 270 disposed more proximate to the filtrate and retentate openings 250, 260 than the feed and drain openings 220, 230, and a second pair of compression pin housings 270 disposed more proximate to the feed and drain openings 220, 230 than the filtrate and retentate openings 250, 260. Each compression pin housing 270, as best illustrated in FIG. 6C, may be configured to house a compression pin 280.

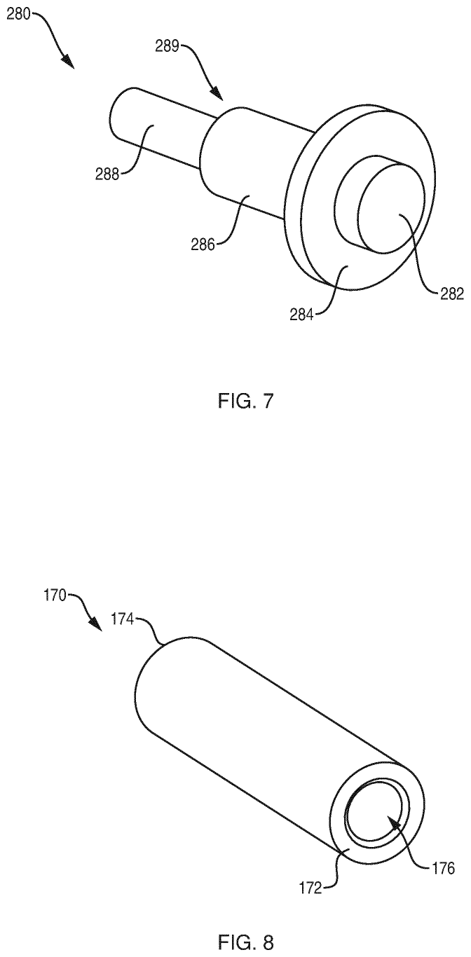

FIG. 7 illustrates a perspective view of the compression pin 280. The compression pin 280 may include a head 282, a flange 284, a first shank portion 286, and a second shank portion 288. The head 282 and the first shank portion 286 may have the same or substantially similar diameter to one another. The flange 284 may have a diameter that is greater than that of the head 282, the first shank portion 286, and the second shank portion 288. The second shank portion 288 may have diameter that is smaller than that of the head 282, the flange 284, and the first shank portion 286. The difference between the diameters of the first shank portion 286 and the second shank portion 288 defines an engagement surface 289. The compression pins 280 may be constructed from any metallic material, plastic material, or other material configured to withstand compression forces of at least approximately five (5) tons. Like the compression limiters 170, the compression pins 280 may be constructed from a stainless steel, including, but not limited to, SAE 316L stainless steel. Thus, the compression pins 280 may have a durometer hardness value in the approximate range of 75 to 95 on the Rockwell B scale.

Returning to FIGS. 6A-6C, each compression pin 280 is disposed within a pin housing 270 such that the head 282 of each compression pin 280 is disposed within in the associated outer compression pin opening 272 on the outer surface 202 of the end cap 200 (as best illustrated in FIGS. 6A and 6C), and such that the second shank portion 288 extends out of the inner compression pin opening 274 (as best illustrated in FIG. 6C). FIG. 6C best illustrates, because the flange 284 has a wider diameter than that of the other head 282, first shank portion 286, and second shank portion 288, and because the flange 284 has a wider diameter than the outer and inner compression pin openings 272, 274, the compression pins 280 are prevented from sliding through the compression pin housings 270. More specifically, the end caps 200 may be injection molded or additive manufactured, like that of the center manifold 100 around the compression limiters 170, around the compression pins 280 to capture the compression pins 280 within the compression pin housings 270. In some additional embodiments, the compression pins 280 may be coupled to the end caps 200 via post molding operations, including, but not limited to, ultrasonic bonding, heat bonding, and/or other mechanical insertion methods.

As further illustrated in FIGS. 6A and 6B, the end caps 200 also include engagement arms 290 that extend rearwardly (i.e., from the inner surface 204) from either the first side end 210 or the second side end 212 of the end cap 200. Each engagement arm 290 may include a proximal end or first end 292 that is coupled to the end cap 200, and an opposite distal end or second engagement end 294. The second engagement end 294 of each engagement arm 290 may include a projection 296. In the illustrated embodiment, the end cap 200 may include two engagement arms 290. One engagement arm 290 may extend rearwardly from the first side end 210 at a location more proximate to the bottom end 208 than the top end 206, while the other engagement arm 290 may extend rearwardly from the second side end 212 at a location more proximate to the top end 206 than the bottom end 208. Each engagement arm 290 may be sized to fit within the upper slot 160 and/or the lower slot 162 of the center manifold 100 in order to removably couple the end caps 200 to the center manifold 100.

As best illustrated in FIGS. 3, 4, and 9C, when the end caps 200 are removably coupled to the center manifold 100 such that one end cap 200 is coupled to the first side 102 of the center manifold 100 and the other end cap 200 is coupled to the second side 104 of the center manifold 100, the engagement arms 290 may extend into one of the upper or lower slots 160, 162 of the first and second elongated ends 110, 112 of the center manifold 100. When an engagement arm 290 is disposed within the upper slot 160, the projection 296 of the engagement arm 290 may be configured to be in abutment with, and engaged with, the engagement flange 164 disposed in the upper slot 160. Similarly, when an engagement arm 290 is disposed within the lower slot 162, the projection of the engagement arm 290 may be configured to be in abutment with, and engaged with, the engagement flange 164 disposed in the lower slot 162. For the illustrated embodiment, given the positions of the engagement arms 290 on the end caps 200, when the end cap 200 is removably coupled to the first side 102 of the center manifold 100, the engagement arm 290 disposed on the first side end 210 of the end cap 200 is disposed within the lower slot 162 of the first elongated end 110 of the center manifold 100, and the engagement arm 290 disposed on the second side end 212 of the end cap 200 is disposed in the upper slot 160 of the second elongated end 112 of the center manifold 100. In addition, when the end cap 200 is removably coupled to the second side 104 of the center manifold 100, the engagement arm 290 disposed on the first side end 210 of the end cap 200 is disposed within the lower slot 162 of the second elongated end 112 of the center manifold 100, and the engagement arm 290 disposed on the second side end 212 of the end cap 200 is disposed in the upper slot 160 of the first elongated end 110 of the center manifold 100. In other embodiments, the engagement arms 290 of an end cap 200 may be disposed in both of the upper slots 160 or both of the lower slots 162, instead of opposing slots 160, 162, when coupled to the center manifold 100. The engagement of the projections 296 of the engagement arms 290 of the end caps 200 with the engagement flanges 164 of the upper and lower slots 160, 162 removably couples the end caps 200 to the center manifold 100 via a snap fit.

Moreover, when the end caps 200 are removably coupled to the center manifold 100, the feed openings 220 of the end cap 200 align with the feed openings 180 of the center manifold 100, regardless of the side 102, 104 of the center manifold 100 in which the end cap 200 is coupled. In addition, the drain openings 230, including the elongated inner surface pathways 232 of the drain openings 230, align with the drain pathways 182 of the center manifold 100. The filtrate openings 250, including the elongated inner surface pathways 252, of the end cap 200 align with the filtrate pathways 186 of the center manifold 100, while the retentate openings 260 of the end cap 200 align with the retentate openings 188 of the center manifold 100. In addition, the reference rod openings 240 of the end cap 200 also align with the reference rod openings 184 of the center manifold when the end cap 200 is coupled to the center manifold 100.

In addition, when the end caps 200 are removably coupled to the center manifold 100, and as best illustrated in FIGS. 9A-9C, the compression pins 280 of the end caps are aligned with, and at least partially disposed within, the compression limiters 170 of the center manifold 100. As illustrated, each compression limiter 170 may be configured to engage with two compression pins 280. More specifically, the second shank portion 288 of one compression pin 280 (e.g., the compression pin 280 of the end cap 200 coupled to the first side 102 of the center manifold 100) may be disposed within the conduit 176 of the compression limiter 170 proximate to the first end 172 of the compression limiter 170, while the second shank portion 288 of the other compression pin 280 (e.g., the compression pin 280 of the end cap 200 coupled to the second side 104 of the center manifold 100) may be disposed within the conduit 176 of the compression limiter 170 proximate to the second end 174 of the compression limiter 170. As further illustrated, when the end caps 200 are removably coupled to the center manifold 100, the engagement surface 289 of the compression pins 280 of the end cap 200 coupled to the first side 102 of the center manifold 100 are disposed against the first end 172 of the compression limiters 170, while the engagement surface 289 of the compression pins 280 of the end cap 200 coupled to the second side 104 of the center manifold 100 are disposed against the second end 174 of the compression limiters 170.

With the end caps 200 and the center manifold 100 being injection molded or manufactured using additive manufacturing techniques, the presence of the compression limiters 170 and the compression pins 280 enable the manifold assembly 50 to withstand a clamping force from the clamp mechanism 44 of the filtration arrangement 40. In other words, the compression limiters 170 and the compression pins 280 enable the manifold assembly 50 to be subjected to compressions forces of at least approximately five (5) tons.

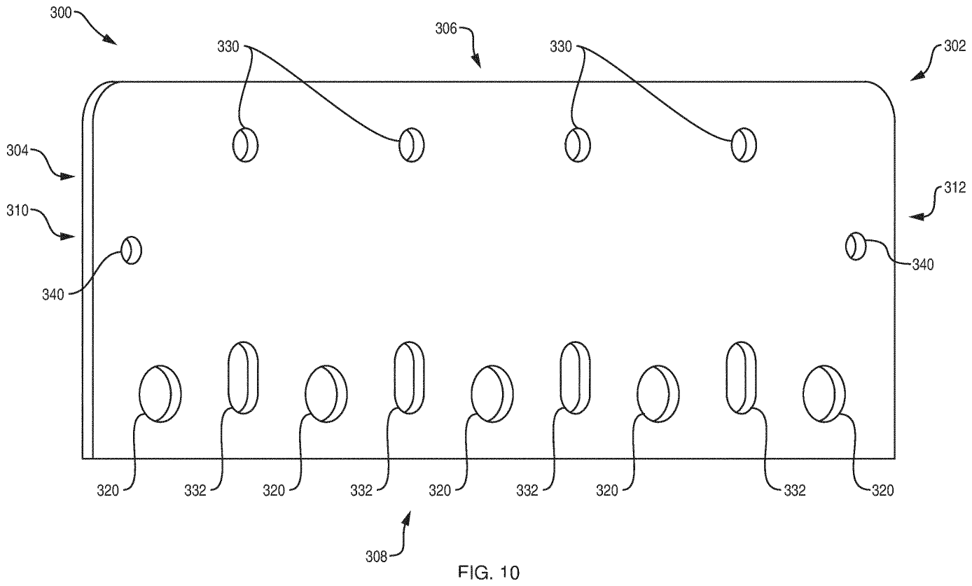

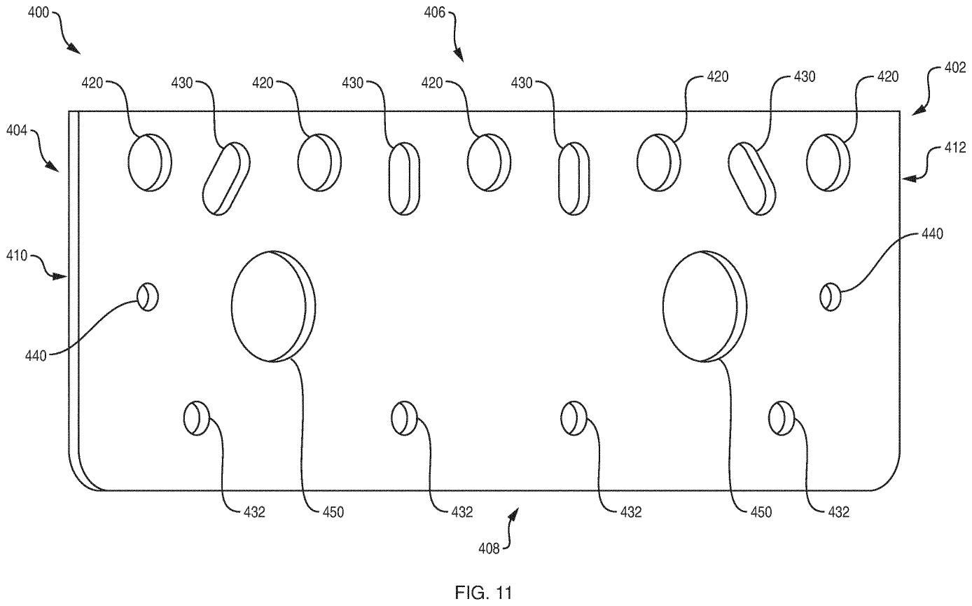

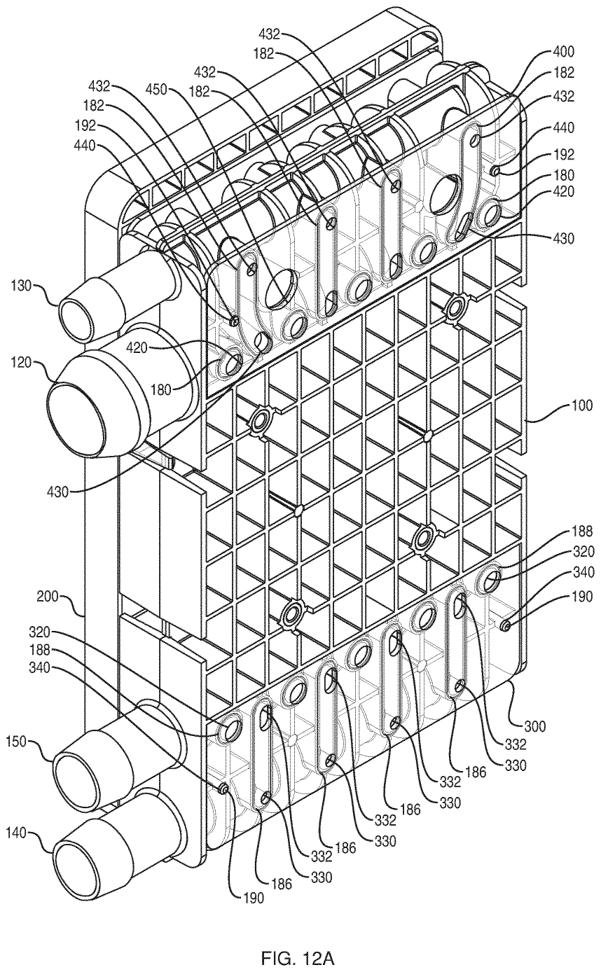

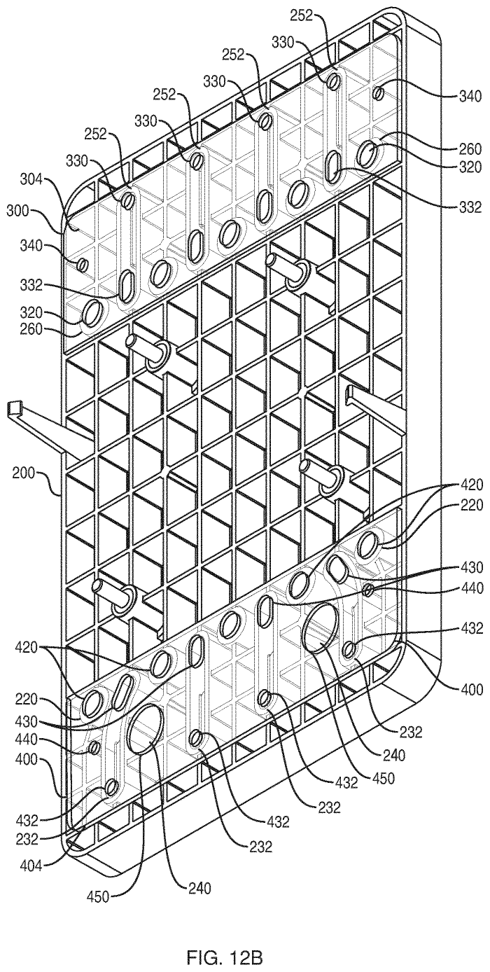

Turning to FIGS. 10, 11, 12A and 12B, illustrated are the upper gaskets 300 and the lower gaskets 400 that may be disposed between the center manifold 100 and the end caps 200 when the end caps 200 are removably coupled to the center manifold 100. The manifold assembly 50 may include two upper gaskets 300 and two lower gaskets 400. The upper gasket 300 is best illustrated in FIGS. 10, 12A, and 12B. While only a single upper gasket 300 is illustrated in FIGS. 10, 12A, and 12B, it should be understood that each of the upper gaskets 300 of the manifold assembly 50 may be identical to one another. Thus, any depiction and/or description of the upper gasket 300 illustrated in FIGS. 10, 12A, and 12B also applies to the other upper gasket 300 of the manifold assembly 50. In addition, the lower gasket 400 is best illustrated in FIGS. 11, 12A, and 12B. While only a single lower gasket 400 is illustrated in FIGS. 11, 12A, and 12B, it should be understood that each of the lower gaskets 400 of the manifold assembly 50 may be identical to one another. Thus, any depiction and/or description of the lower gasket 400 illustrated in FIGS. 11, 12A, and 12B also applies to the other lower gasket 400 of the manifold assembly 50.

As best illustrated in FIG. 10, the upper gasket 300 include an outer surface 302 and an inner surface 304 opposite the outer surface 302. The upper gasket 300 may have a substantially rectangular shape with a top edge 306, a bottom edge 308 opposite the top edge 306, a first side edge 310 spanning from the top edge 306 to the bottom edge 308, and a second side edge 312 opposite the first side edge 310 and also spanning from the top edge 306 to the bottom edge 308. The upper gasket 300 may include a series of retentate openings 320, a series of upper filtrate openings 330, and a series of lower filtrate openings 332. The retentate openings 320 and the lower filtrate openings 332 may be disposed in the upper gasket 300 more proximate to the bottom edge 308 than the top edge 306, while the upper filtrate openings 330 may be disposed more proximate to the top edge 306 than the bottom edge 308. The retentate opening 320 and the lower filtrate openings 332 may be substantially horizontally aligned from the first side edge 310 to the second side edge 312, and may be arranged in an alternation fashion. Thus, as illustrated, each lower filtrate opening 332 may be disposed between two retentate openings 320. The upper filtrate openings 330 may be aligned substantially horizontally from the first side edge 310 to the second side edge 312. Moreover, each upper filtrate opening 330 may be aligned substantially vertically with a corresponding lower filtrate opening 332. In the illustrated embodiment, the lower filtrate openings 332 may be substantially stadium or capsule shaped, while the retentate openings 320 and the upper filtrate openings 330 may be substantially circular shaped. In other embodiments, the openings 320, 330, 332 may be of any other shape, and the openings 320, 330, 332 may be of the same shape or of different shapes from one another.

As further illustrated, the upper gasket 300 may include two alignment openings 340, where one alignment opening 340 is disposed more proximate to the first side edge 310 than the second side edge 312, and the other alignment opening 340 is disposed more proximate to the second side edge 312 than the first side edge 310. The alignment openings 340 may be sized and shaped to receive the upper gasket alignment projections 190 of the center manifold 100.

As best illustrated in FIG. 12A, when the upper gasket 300 is disposed against the center manifold 100 (i.e., when the upper gasket 300 is sandwiched between the center manifold 100 and an end cap 200), the upper gasket alignment projections 190 may be disposed within the alignment openings 340 of the upper gasket 300. Moreover, the retentate openings 320 of the upper gasket 300 may be disposed within the retentate openings 188. The upper filtrate openings 330 may be aligned with the upper end of the filtrate pathways 186 of the center manifold 100, while the lower filtrate openings 332 may be aligned with the lower end of the filtrate pathways 186 of the center manifold 100.

As best illustrated in FIG. 12B, when the upper gasket 300 is disposed against the inner surface 204 of the end cap 200 (i.e., when the upper gasket 300 is sandwiched between the center manifold 100 and an end cap 200), the retentate openings 320 of the upper gasket 300 may be aligned with the retentate openings 260 of the end cap 200. Furthermore, the upper filtrate openings 330 of the upper gasket 300 may be aligned with the upper end of the elongated inner surface pathway 252 of the filtrate openings 250 of the end cap 200, while the lower filtrate openings 332 may be aligned with the lower end of the elongated inner surface pathway 252 of filtrate openings 250 of the end cap 200.

The upper gasket 300 may facilitate a seal between the center manifold 100 and the end cap 200, and around the filtrate pathways 186, retentate openings 188, the retentate openings 260, and the filtrate openings 250. The upper gasket 300 may be constructed from any material configured to facilitate a seal between surfaces, including, but not limited to, rubber, silicone, neoprene, cork, thermoplastic elastomers, (TPE), etc.

Returning to FIG. 11, the lower gasket 400, like the upper gasket 300, includes an outer surface 402 and an inner surface 404 opposite the outer surface 402. The lower gasket 400 may have a substantially rectangular shape with a top edge 406, a bottom edge 408 opposite the top edge 406, a first side edge 410 spanning from the top edge 406 to the bottom edge 408, and a second side edge 412 opposite the first side edge 410 and also spanning from the top edge 406 to the bottom edge 408. The lower gasket 400 may include a series of feed openings 420, a series of upper drain openings 430, and a series of lower drain openings 432. The feed openings 420 and the upper drain openings 430 may be disposed in the lower gasket 400 more proximate to the top edge 406 than the bottom edge 408, while the lower drain openings 432 may be disposed more proximate to the bottom edge 408 than the top edge 406. The feed openings 420 and the upper drain openings 430 may be substantially horizontally aligned from the first side edge 410 to the second side edge 412, and may be arranged in an alternation fashion. Thus, as illustrated, each upper drain opening 430 may be disposed between two feed openings 420. The lower drain openings 432 may be aligned substantially horizontally from the first side edge 410 to the second side edge 412. Moreover, each upper drain opening 430 may be aligned substantially vertically with a corresponding lower drain opening 432. In the illustrated embodiment, the upper drain openings 430 may be substantially stadium or capsule shaped, while the feed openings 420 and the lower drain openings 432 may be substantially circular shaped. In other embodiments, the openings 420, 430, 432 may be of any other shape, and the openings 420, 430, 432 may be of the same shape or of different shapes from one another.

As further illustrated, the lower gasket 400 may include two alignment openings 440, where one alignment opening 440 is disposed more proximate to the first side edge 410 than the second side edge 412, and the other alignment opening 440 is disposed more proximate to the second side edge 412 than the first side edge 410. The alignment openings 440 may be sized and shaped to receive the lower gasket alignment projections 192 of the center manifold 100. The lower gasket 400 may further include a pair of reference rod openings 450 that are disposed between the horizontally aligned lower drain openings 432 and the horizontally aligned feed openings 420 and upper drain openings 430.

As best illustrated in FIG. 12A, when the lower gasket 400 is disposed against the center manifold 100 (i.e., when the lower gasket 400 is sandwiched between the center manifold 100 and an end cap 200), the lower gasket alignment projections 192 of the center manifold 100 may be disposed within the alignment openings 440 of the lower gasket 400. Moreover, the feed openings 420 of the lower gasket 400 may be aligned with the feed openings 180. The upper drain openings 430 may be aligned with the upper end of the drain pathways 182 of the center manifold 100, while the lower drain openings 432 may be aligned with the lower end of the drain pathways 182 of the center manifold 100. In addition, the reference rod openings 450 of the lower gasket 400 may be aligned with the reference rod openings 184 of the center manifold 100.

As best illustrated in FIG. 12B, when the lower gasket 400 is disposed against the inner surface 204 of the end cap 200 (i.e., when the lower gasket 400 is sandwiched between the center manifold 100 and an end cap 200), the feed openings 420 of the lower gasket 400 may be aligned with the feed openings 220 of the end cap 200. Furthermore, the upper drain openings 430 of the lower gasket 400 may be aligned with the upper end of the elongated inner surface pathway 232 of the drain openings 230 of the end cap 200, while the lower drain openings 432 may be aligned with the lower end of the elongated inner surface pathway 232 of drain openings 230 of the end cap 200. Additionally, the reference rod openings 450 of the lower gasket 400 may be aligned with the reference rod openings 240 of the end cap 200.

Like the upper gasket 300, the lower gasket 400 may facilitate a seal between the center manifold 100 and the end cap 200, and may seal around the feed openings 180, the drain pathways 182, the feed openings 220, and the drain openings 230. The lower gasket 400 may be constructed from any material configured to facilitate a seal between surfaces, including, but not limited to, rubber, silicone, neoprene, cork, thermoplastic elastomers (TPE), etc.

Turning to FIGS. 13-17, illustrated are various cross-sectional views of the manifold assembly 50 that depict the various flow pathways though the manifold assembly 50, especially when the manifold assembly 50 is disposed within the clamping mechanism 44 of the filtration arrangement 40, and aligned with filtration cassettes 60. The flow pathway of the feed liquid is best shown in FIG. 13. The feed liquid flows into the manifold assembly 50 via the feed port 120, and into the feed conduit 122. As previously explained, the feed conduit 122 includes a series of feed outlets 124 that are aligned with the feed openings 180 on both sides 102, 104 of the center manifold 100, the feed openings 420 of the lower gaskets 400 disposed on both sides 102, 104 of the center manifold 100, and the feed openings 220 of the end caps 200 attached to both sides 102, 104 of the center manifold 100. Thus, as illustrated, the feed liquid flows into the feed port 120, through the feed conduit 122, and out of the feed outlets 124 of the feed conduit 122. The feed liquid then flows through the feed openings 180 of the center manifold 100, the feed openings 420 of the lower gaskets 400, the feed openings 220 of the end caps 200, and into the filtration cassettes 60 that are disposed on either side 52, 53 of the manifold assembly 50.

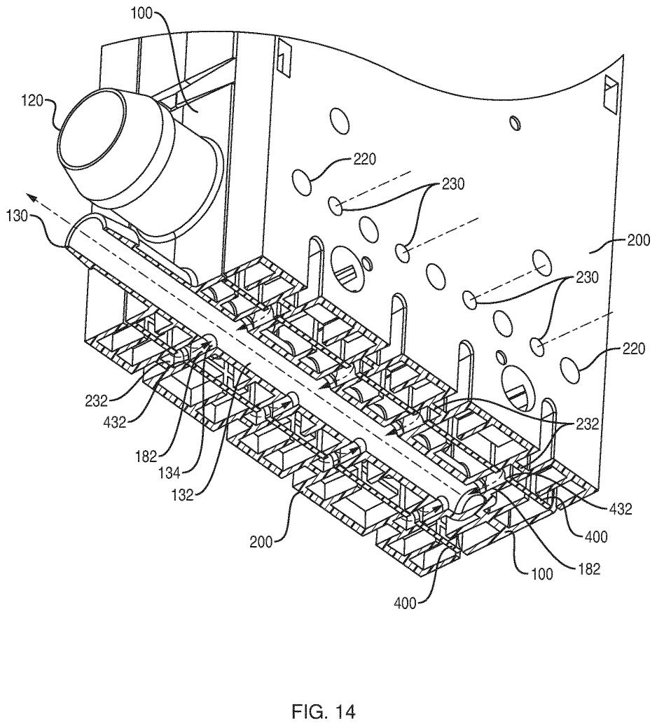

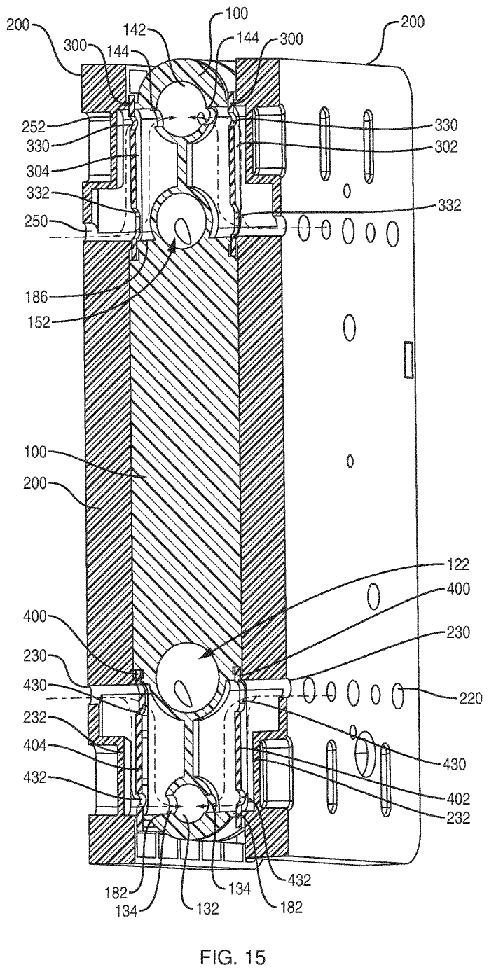

As previously explained, as the liquid flows through the filtration cassettes 60, the liquid is filtered into a drain liquid, a filtrate liquid, and a retentate liquid that return, via the filtration cassettes 60 to the manifold assembly 50 in order to flow back to the treatment device 32. FIGS. 14 and 15 illustrate the flow pathway of the drain liquid from the filtration cassettes 60 into the manifold assembly 50, and out of the drain port 130. More specifically, the drain liquid flows into the manifold assembly 50 via the drain openings 230 of the end caps 200. The drain liquid may then split into a first split drain liquid and a second split drain liquid. The first split drain liquid may flow downward through a first passageway defined by the outer surface 402 of the lower gaskets 400 and the elongated inner surface pathway 232 of the drain opening 230 that is disposed on the inner surface 204 of the end caps 200. The first split drain liquid then flows through the lower drain openings 432 of the lower gaskets 400. The second split drain liquid may flow through the upper drain openings 430 of the lower gaskets 400, and then downward through a second passageway defined by the drain pathways 182 of the center manifold 100 and the inner surface 404 of the lower gaskets 400. The two split drain liquids may mix or combine with one another at the lower end of the drain pathways 182 of the center manifold 100 before the drain liquid then flows through the drain inlets 134 of the drain conduit 132. Finally, the drain liquid may then flow through the drain conduit 132 and out of the drain port 130.

FIGS. 15 and 16 illustrate the flow pathway of the filtrate liquid from the filtration cassettes 60 into the manifold assembly 50, and out of the filtrate port 140. More specifically, the filtrate liquid flows into the manifold assembly 50 via the filtrate openings 250 of the end caps 200. The filtrate liquid may then split into a first split filtrate liquid and a second split filtrate liquid. The first split filtrate liquid may flow upward through a first passageway defined by the outer surface 302 of the upper gaskets 300 and the elongated inner surface pathway 252 of the filtrate opening 250 that is disposed on the inner surface 204 of the end caps 200. The first split filtrate liquid may then through the upper filtrate openings 330 of the upper gaskets 300. The second split filtrate liquid may flow through the lower filtrate openings 332 of the upper gaskets 300, and then upward through a second passageway defined by the filtrate pathways 186 of the center manifold 100 and the inner surface 304 of the upper gaskets 300. The two split filtrate liquids may mix or combine with one another at the upper end of the filtrate pathways 186 of the center manifold 100 before the filtrate liquid then flows through the filtrate inlets 144 of the filtrate conduit 142. Finally, the filtrate liquid may then flow through the filtrate conduit 142 and out of the filtrate port 140.

FIG. 17 illustrates the flow pathway of the retentate liquid from the filtration cassettes 60 into the manifold assembly 50, and out of the retentate port 150. More specifically, the retentate liquid flows into the manifold assembly 50 via the retentate openings 260 of the end caps 200. Because the retentate openings 260 of the end caps 200 are aligned with the retentate openings 320 of the upper gaskets 300 and the retentate openings 188 of the center manifold 100, the retentate liquid then flows, after flowing through the retentate openings 260 of the end caps 200, through the retentate openings 320 of the upper gaskets 300 and the retentate openings 188 of the center manifold 100. The retentate liquid then flows through the retentate inlets 154 and into the retentate conduit 152. Finally, the retentate liquid may then flow through the retentate conduit 152 and out of the retentate port 150.

The manifold assembly 50 disclosed herein provides a single-use manifold assembly that is injection molded or manufactured using additive manufacturing processes, and that provides improvements over traditional stainless steel manifolds. The manifold assembly 50, as explain above, includes a center manifold 100, two end caps 200 that are removably couplable to the center manifold 100 (via snap fit arrangement or other known removably couplable fashion), and gaskets 300, 400 disposed between the center manifold 100 and the end caps 200. The center manifold 100 and the end caps 200 may be injection molded to at least partially capture the compression limiters 170 within the center manifold 100 and at least partially capture the compression pins 280 within the end caps 200. In other embodiments, the compression limiters 170 and the compression pins 280 may be coupled to the center manifold 100 and the end caps 200, respectively, via post molding operations, including, but not limited to, ultrasonic bonding, heat bonding, and/or other mechanical insertion methods. Constructing the center manifold 100 and the end caps 200 in this manner enables the manifold assembly 50 to be sterilized via any known sterilization methods, including, but not limited to, gamma irradiation, autoclaving, and other gas-or vapor-based sterilization methods, such as, but not limited to, ethylene oxide, chlorine dioxide, ozone, supercritical carbon dioxide, and vaporized hydrogen peroxide. In addition, constructing the center manifold 100 and the end caps 200 in this manner further enables the ports 120, 130, 140, 150 of the center manifold 100 to all be disposed on the same side of the manifold assembly 50. This makes the manifold assembly 50 more ergonomic for an operator to use and set up in a clamping mechanism 44 of a filtration arrangement 40. Constructing the center manifold 100 and the end caps 200 in this manner also enables the manifold assembly 50 disclosed herein to be lighter in weight than conventional stainless steel manifolds. Moreover, by constructing the manifold assembly 50 from various components that are removably coupled to one another, individual components (e.g., the center manifold 100, the end caps 200, the gaskets 300, 400, etc.) of the manifold assembly 50 may be replaced if damaged instead of the entire manifold assembly 50.

While the apparatuses presented herein have been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. For example, the flow pathways presented herein may be modified to contain any number of channels, deviations, cavities, inlets, and outlets, the components of the manifold assembly presented herein may include any number of ports, openings, and apertures, and the manifold assembly may include any number of components, end caps, compression pins, compression limiters, and gaskets.

In addition, various features from one of the embodiments may be incorporated into another of the embodiments. That is, it is believed that the disclosure set forth above encompasses multiple distinct inventions with independent utility. While each of these inventions has been disclosed in a preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention. Additionally, it is also to be understood that the components of the bioprocessing system described herein, the manifold assembly described herein, or portions thereof may be fabricated from any suitable material or combination of materials, such as, but not limited to, thermoplastics, plastics, or metals (e.g., copper, bronze, aluminum, steel, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising,” etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about,” “around,” “generally,” and “substantially.”

What is claimed is:

1. A manifold assembly for a tangential flow filtration assembly, the manifold assembly comprising:
a manifold having a first surface, a second surface opposite the first surface, a first edge spanning between the first surface and the second surface, and a second edge spanning between the first surface and the second surface, the second edge being opposite the first edge;
a feed port extending from the first edge of the manifold;
a retentate port extending from the first edge of the manifold; and
a filtrate port extending from the first edge of the manifold.

2. The manifold assembly according to claim 1, further comprising:
an end cap removably coupled to either the first surface or the second surface of the manifold.

3. The manifold assembly according to claim 2, wherein the manifold further comprises:
a first series of openings in fluid communication with the feed port;
a second series of openings in fluid communication with the retentate port; and
a third series of openings in fluid communication with the filtrate port.

4. The manifold assembly according to claim 3, wherein the end cap further comprises:
a fourth series of openings extending through the end cap;
a fifth series of openings extending through the end cap; and
a sixth series of openings extending through the end cap.

5. The manifold assembly according to claim 4, wherein, when the end cap is removably coupled to the manifold, the fourth series of openings of the end cap are aligned with the first series of openings of the manifold, the fifth series of openings of the end cap are aligned with the second series of openings of the manifold, and the sixth series of openings of the end cap are aligned with the third series of openings of the manifold.

6. A manifold assembly for a tangential flow filtration assembly, the manifold assembly comprising:
a manifold having a first surface and a second surface opposite the first surface;
a compression limiter at least partially captured within the manifold such that the compression limiter extends from the first surface to the second surface of the manifold; and
an end cap coupled to the first surface of the manifold.

7. The manifold assembly according to claim 6, wherein the manifold is injection molded or additively manufactured around the compression limiter.

8. The manifold assembly according to claim 7, wherein the end cap includes an outer surface and an inner surface opposite the outer surface.

9. The manifold assembly according to claim 8, further comprising:
a compression pin at least partially captured within the end cap such that a portion of the compression pin extends from the inner surface of the end cap.

10. The manifold assembly according to claim 9, wherein, when the end cap is coupled to the manifold, the compression pin is aligned with the compression limiter.

11. The manifold assembly according to claim 9, wherein the compression limiter is a cylinder having a conduit.

12. The manifold assembly according to claim 11, wherein, when the end cap is coupled to the manifold, the compression pin is abutted against an end of the compression limiter and the portion of the compression pin is disposed within the conduit of the compression limiter.

13. The manifold assembly according to claim 9, wherein the end cap and the manifold have a first durometer value.

14. The manifold assembly according to claim 13, wherein the compression limiter and the compression pin have a second durometer value that is greater than the first durometer value.

15. A manifold assembly for a tangential flow filtration assembly, the manifold assembly comprising:
a manifold having a first surface, a second surface opposite the first surface, and a plurality of ports extending from a first edge of the manifold, the manifold further including a plurality of first openings extending into the manifold on the first surface and in fluid communication with the plurality of ports; and
an end cap having an inner surface, an outer surface, and a plurality of second openings extending through the end cap from the inner surface to the outer surface, the plurality of second openings being aligned with the plurality of first openings when the end cap is coupled to the first surface the manifold.

16. The manifold assembly according to claim 15, wherein the inner surface of the end cap is disposed more proximate to the first surface of the manifold than the outer surface of the end cap when the end cap is coupled to the manifold.

17. The manifold assembly according to claim 16, further comprising at least one gasket disposed between the first surface of the manifold and the inner surface of the end cap.

18. The manifold assembly according to claim 16, wherein the manifold further includes a plurality of first pathways disposed on the first surface.

19. The manifold assembly according to claim 18, wherein the end cap further includes a plurality of second pathways disposed on the inner surface.

20. The manifold assembly according to claim 19, wherein, when the end cap is coupled to the manifold, the plurality of first pathways and the plurality of second pathways collectively form a passageway through at least a portion of the manifold assembly.
